(19) United States
(12) Patent Application Publication
(10) Pub. No.: US 2015/0226110 A1
(43) Pub. Date: Aug. 13, 2015

(54) TURBOCHARGER WASTE-GATE VALVE ASSEMBLY WEAR REDUCTION

(71) Applicant: GM GLOBAL TECHNOLOGY OPERATIONS LLC, Detroit, MI (US)

(72) Inventors: Yucong Wang, West Bloomfield, MI (US); Louis P. Begin, Rochester, MI (US)

(73) Assignee: GM GLOBAL TECHNOLOGY OPERATIONS LLC, Detroit, MI (US)

(21) Appl. No.: 14/175,316

(22) Filed: Feb. 7, 2014

(51) Int. Cl. F02B 37/18

(52) U.S. Cl. CPC F02B 37/186

(57) ABSTRACT

A turbocharger for an internal combustion engine includes a rotating assembly having a turbine wheel disposed inside a turbine housing and a compressor wheel disposed inside a compressor cover. The turbocharger also includes a waste-gate assembly configured to selectively redirect at least a portion of the engine's post-combustion gases away from the turbine wheel. The waste-gate assembly includes a valve, a rotatable shaft connected to the valve, and a bushing fixed relative to the turbine housing and disposed concentrically around the shaft such that the shaft rotates inside the bushing to thereby selectively open and close the valve. The shaft is defined by an outer surface in contact with the bushing and the outer surface includes a coating composed of a ceramic-based material. An internal combustion engine employing such a turbocharger is also disclosed.

### TECHNICAL FIELD

The present disclosure relates to a reduced wear waste-gate valve assembly for a turbocharger.

### BACKGROUND

Internal combustion engines (ICE) are often called upon to generate considerable levels of power for prolonged periods of time on a dependable basis. Many such ICE assemblies employ a supercharging device, such as an exhaust gas turbine driven turbocharger, to compress the airflow before it enters the intake manifold of the engine in order to increase power and efficiency.

Specifically, a turbocharger is a centrifugal gas compressor that forces more air and, thus, more oxygen into the combustion chambers of the ICE than is otherwise achievable with ambient atmospheric pressure. The additional mass of oxygen-containing air that is forced into the ICE improves the engine's volumetric efficiency, allowing it to burn more fuel in a given cycle, and thereby produce more power. Frequently, such turbochargers are driven by the engine's exhaust gases.

A typical exhaust gas driven turbocharger includes a central shaft that is supported by one or more bearings and that transmits rotational motion between a turbine wheel and an air compressor wheel. Both the turbine and compressor wheels are fixed to the shaft, which in combination with various bearing components constitute the turbocharger's rotating assembly. Turbochargers frequently employ waste-gate valves to limit operational speeds of the rotating assembly in order to maintain turbocharger boost within prescribed limits and prevent rotating assembly over speed.

### SUMMARY

One embodiment of the disclosure is directed to a turbocharger for pressurizing an airflow for delivery to an internal combustion engine having a cylinder that is configured to receive an air-fuel mixture for combustion therein. The engine also includes a reciprocating piston disposed inside the cylinder and configured to exhaust post-combustion gases therefrom. The turbocharger includes a turbine housing and a compressor cover, a rotating assembly having a turbine wheel disposed inside the turbine housing, and a compressor wheel disposed inside the compressor cover. The compressor wheel is configured to be rotated about an axis by the post-combustion gases.

The turbocharger also includes a waste-gate assembly configured to selectively redirect at least a portion of the post-combustion gases away from the turbine wheel and thereby limit rotational speed of the rotating assembly and pressure of the airflow received from the ambient. The waste-gate assembly includes a valve, a rotatable shaft connected to the valve, and a bushing fixed relative to the turbine housing and disposed concentrically around the shaft such that the shaft rotates inside the bushing to thereby selectively open and close the valve. The shaft is defined by an outer surface in contact with the bushing. The outer surface includes a coating composed of a ceramic-based material.

The bushing may be defined by an inner surface that is in contact with the shaft. The inner surface may be at least partially coated with the ceramic-based material. The coating may be applied via a physical deposition or a thermal spray process.

The bushing may be defined by an inner surface in contact with the shaft. The inner surface may include an insert or multiple inserts configured at least partially from the ceramic-based material. Each insert maybe configured as a continuous sleeve or as a discrete section.

The waste-gate assembly may also include an arm fixed to the shaft. The waste-gate assembly may additionally include an actuator having a rod operatively connected to the arm via a rod end and configured to displace or rotate the arm to thereby selectively open and close the valve. The rod end may include an insert configured from the ceramic-based material. Additionally, the rod end may define an aperture and the arm may include a pin that is engaged with the aperture. Accordingly, the pin's engagement with the aperture provides and secures an interface between the rod end and the pin. The insert may be disposed at the interface.

The inorganic crystalline or ceramic-based material may have a matric composite structure that includes both ceramic and non-ceramic materials. For example, the ceramic-based material may be one of a silicon carbide, silicon nitride, chromium carbide, zirconia, carbon-carbon composite, and metal-ceramic composite.

The ceramic-based material may also have a substantially homogenous crystalline structure.

Another embodiment of the present disclosure is directed to an internal combustion engine having the turbocharger as described above.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a perspective view of an engine with a turbocharger according to an embodiment of the disclosure.

FIG. 2 is a perspective partial cross-sectional view of the turbocharger shown in FIG. 1, showing a waste-gate assembly that includes a valve, a rotatable shaft connected to the valve, a bushing, an arm fixed to the shaft, and an actuator having a rod.

FIG. 3 is a schematic partial cross-sectional view of the turbocharger shown in FIGS. 1 and 2.

FIG. 4 is a close up cross-sectional side view of the shaft and bushing subassembly shown in FIG. 2 according to one embodiment.

FIG. 5 is a close up cross-sectional side view of the shaft and bushing subassembly shown in FIG. 2 according to an alternate embodiment.

FIG. 6 is a close up cross-sectional side view of the shaft and bushing subassembly shown in FIG. 2 according to a yet another alternate embodiment.

FIG. 7 is a close up cross-sectional side view of the rod and arm sub-assembly shown in FIG. 2.

### DETAILED DESCRIPTION

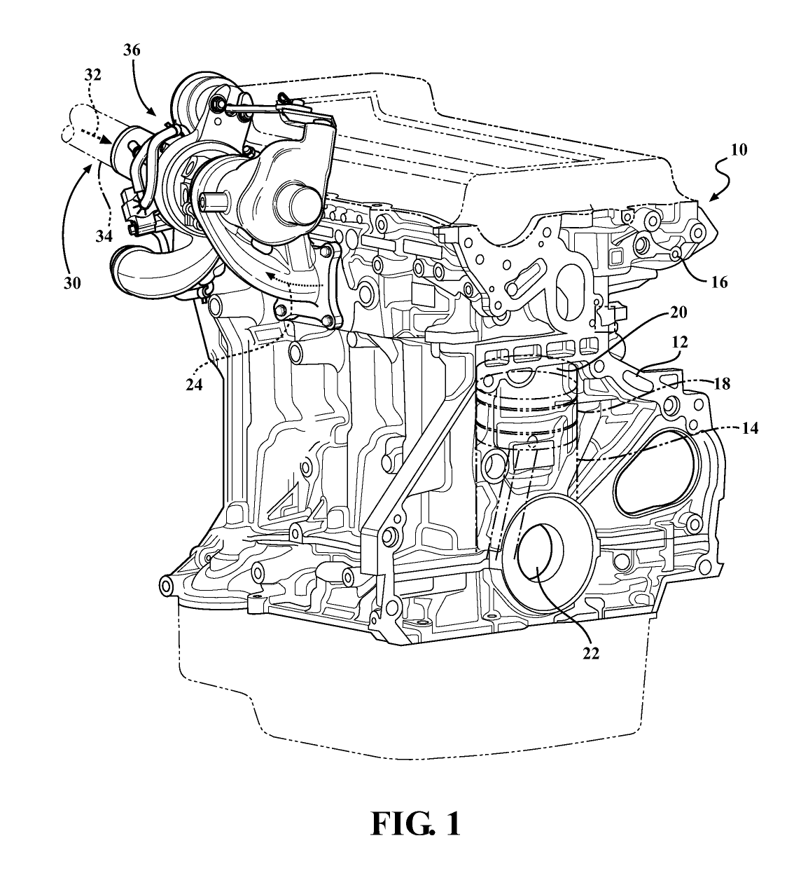

Referring to the drawings wherein like reference numbers correspond to like or similar components throughout the several figures, FIG. 1 illustrates an internal combustion engine 10. The engine 10 also includes a cylinder block 12 with a plurality of cylinders 14 arranged therein. As shown in FIG. 1, the engine 10 may also include a cylinder head 16 that is mounted on the cylinder block 12. Each cylinder 14 includes a piston 18 configured to reciprocate therein.

Combustion chambers 20 are formed within the cylinders 14 between the bottom surface of the cylinder head 16 and the tops of the pistons 18. As known by those skilled in the art, each of the combustion chambers 20 receives fuel and air from the cylinder head 16 that form a fuel-air mixture for subsequent combustion inside the subject combustion chamber. The cylinder head 16 is also configured to exhaust post-combustion gases from the combustion chambers 20. The engine 10 also includes a crankshaft 22 configured to rotate within the cylinder block 12. The crankshaft 22 is rotated by the pistons 18 as a result of an appropriately proportioned fuel-air mixture being burned in the combustion chambers 20. After the air-fuel mixture is burned inside a specific combustion chamber 20, the reciprocating motion of a particular piston 18 serves to exhaust post-combustion gases 24 from the respective cylinder 14.

The engine 10 additionally includes an induction system 30 configured to channel an airflow 32 from the ambient to the cylinders 14. The induction system 30 includes an intake air duct 34, a turbocharger 36, and an intake manifold (not shown). Although not shown, the induction system 30 may additionally include an air filter upstream of the turbocharger 36 for removing foreign particles and other airborne debris from the airflow 32. The intake air duct 34 is configured to channel the airflow 32 from the ambient to the turbocharger 36, while the turbocharger is configured to pressurize the received airflow, and discharge the pressurized airflow to the intake manifold. The intake manifold in turn distributes the previously pressurized airflow 32 to the cylinders 14 for mixing with an appropriate amount of fuel and subsequent combustion of the resultant fuel-air mixture.

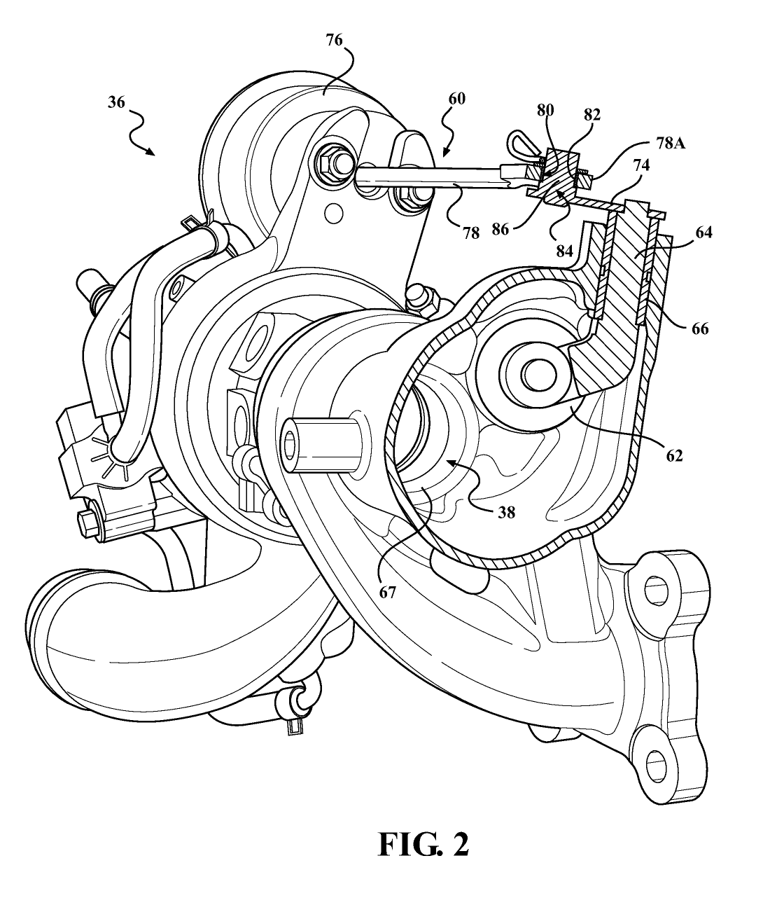

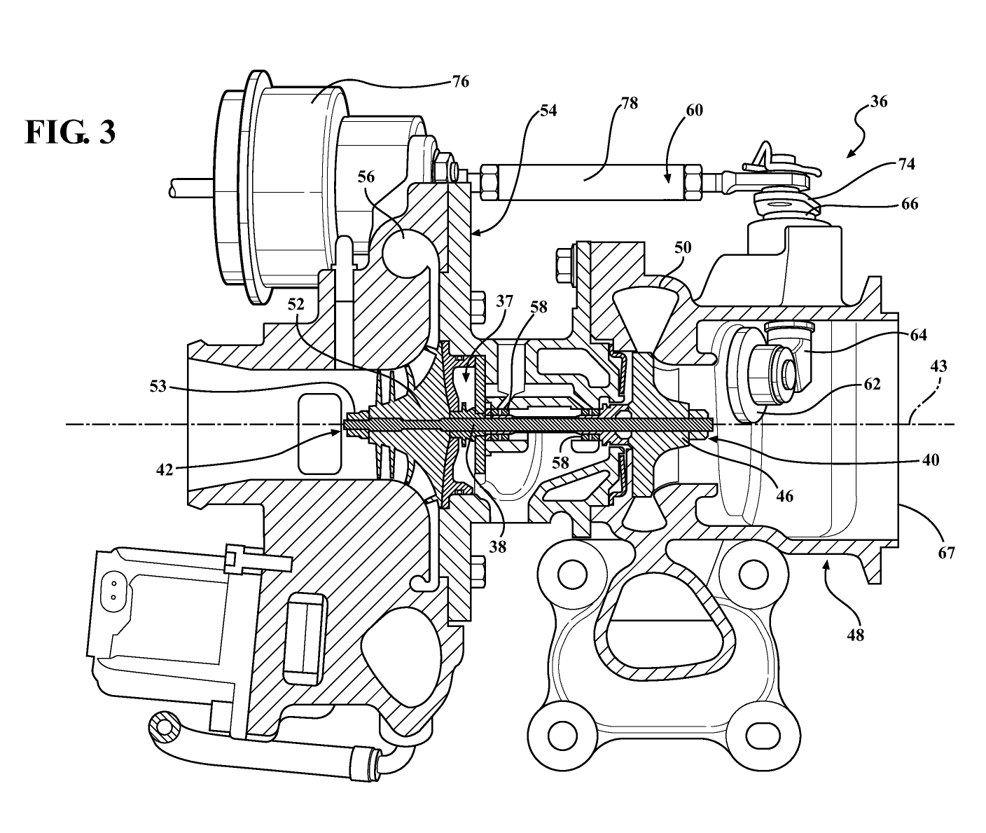

As shown in FIGS. 2-3, the turbocharger 36 includes a rotating assembly 37. The rotating assembly 37 includes a shaft 38 having a first end 40 and a second end 42. The rotating assembly 37 also includes a turbine wheel 46 mounted on the shaft 38 proximate to the first end 40 and configured to be rotated along with the shaft 38 about an axis 43 by post-combustion gases 24 emitted from the cylinders 14. The turbine wheel 46 is typically formed from a temperature and oxidation resistant material, such as a nickel-chromium-based “inconel” super-alloy to reliably withstand temperatures of the post-combustion gases 24, which in some engines may approach 2,000 degrees Fahrenheit. The turbine wheel 46 is disposed inside a turbine housing 48 that includes a turbine volute or scroll 50. The turbine scroll 50 receives the post-combustion exhaust gases 24 and directs the exhaust gases to the turbine wheel 46. The turbine scroll 50 is configured to achieve specific performance characteristics, such as efficiency and response, of the turbocharger 36.

As further shown in FIG. 3, the rotating assembly 37 also includes a compressor wheel 52 mounted on the shaft 38 between the first and second ends 40, 42. The compressor wheel 52 is retained on the shaft 38 via a specially configured fastener, such as a jam nut 53. As understood by those skilled in the art, a jam nut 53 is a type of fastener that includes pinched or unequal thread pitch internal threads to engage external threads of a mating component, for example the shaft 38. Such a thread configuration of the jam nut 53 serves to minimize the likelihood of the jam nut coming loose from the shaft 38 during operation of the turbocharger 36. Additionally, the direction of the thread on the jam nut 53 may be selected such that the jam nut will have a tendency to tighten rather than loosen as the shaft 38 is spun up by the post-combustion gases 24.

The compressor wheel 52 is configured to pressurize the airflow 32 being received from the ambient for eventual delivery to the cylinders 14. The compressor wheel 52 is disposed inside a compressor cover 54 that includes a compressor volute or scroll 56. The compressor scroll 56 receives the airflow 32 and directs the airflow to the compressor wheel 52. The compressor scroll 56 is configured to achieve specific performance characteristics, such as peak airflow and efficiency of the turbocharger 36. Accordingly, rotation is imparted to the shaft 38 by the post-combustion exhaust gases 24 energizing the turbine wheel 46, and is in turn communicated to the compressor wheel 52 owing to the compressor wheel being fixed on the shaft.

The rotating assembly 37 is supported for rotation about the axis 43 via journal bearings 58. During operation of the turbocharger 36, the rotating assembly 37 may frequently operate at speeds over 100,000 revolutions per minute (RPM) while generating boost pressure for the engine 10. As understood by those skilled in the art, the variable flow and force of the post-combustion exhaust gases 24 influences the amount of boost pressure that may be generated by the compressor wheel 52 throughout the operating range of the engine 10.

With resumed reference to both FIGS. 2 and 3, the turbocharger 36 includes a waste-gate assembly 60. The waste-gate assembly 60 is configured to selectively redirect at least a portion of the post-combustion exhaust gases 24 away from the turbine wheel 46 and thereby limit rotational speed of the rotating assembly 37 and pressure of the airflow 32 received from the ambient. The waste-gate assembly 60 includes a valve 62, a rotatable shaft 64 connected to the valve 62 and a bushing 66 fixed relative to the turbine housing 48, such as by a pin (not shown). As maybe seen from FIG. 3, the bushing 66 is disposed concentrically around the shaft 64 such that the shaft rotates inside the bushing to thereby selectively open and close the valve 62 for controlling a bypass (not shown) for post-combustion exhaust gases 24 between the scroll 50 and a turbine housing outlet 67.

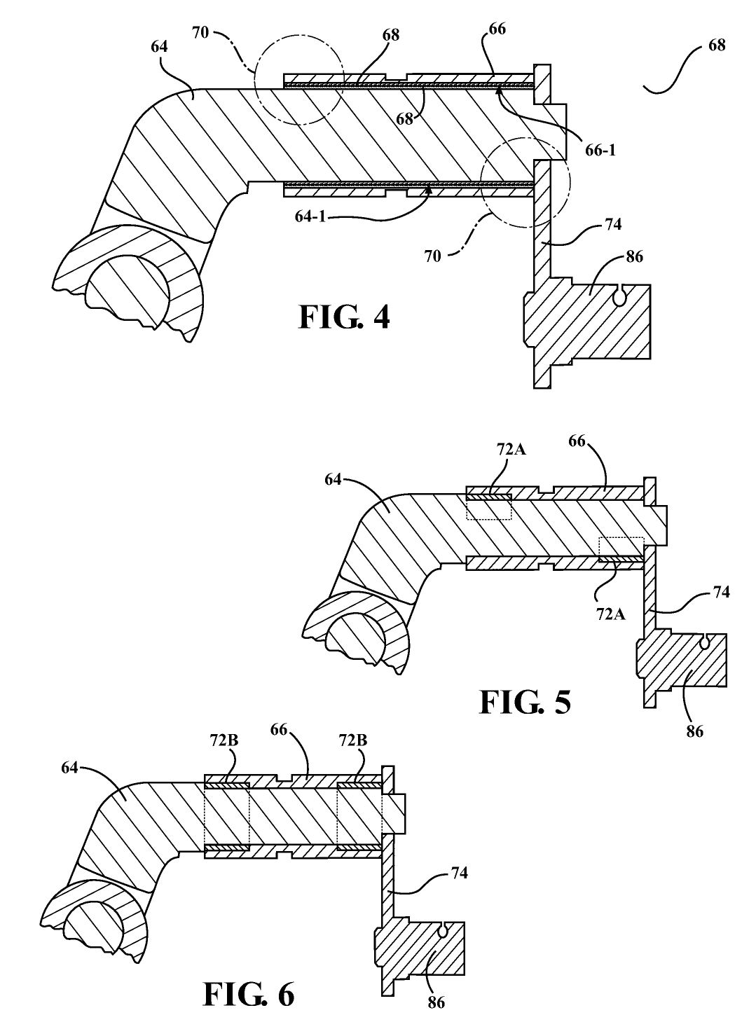

As shown in FIG. 4, the shaft 64 is defined by an outer surface 64-1, while the bushing 66 is defined by an inner surface 66-1. The outer surface 64-1 is in contact with and rotates relative to the inner surface 66-1 when the waste-gate valve assembly 60 is operated. The outer surface 64-1 includes a ceramic-based coating 68. The ceramic-based coating 68 is to be selected based on having a material hardness that exceeds that of typical hardened steels. Additionally, the ceramic-based coating 68 is to be selected for its resistance to abrasion at elevated temperatures that are likely to be encountered by the turbocharger 36 during operation. The coating 68 may cover the entirety of the outer surface 64-1 or be disposed in predetermined locations 70 of highest specific loading, i.e., pressure, between the shaft 64 and the bushing 66 during operation of the waste-gate assembly 60. The locations 70 of highest specific loading between the shaft 64 and the bushing 66 may be identified via analytical tools, such as Finite Element Analysis (FEA), and/or empirically during testing and development of the turbocharger 36.

The coating 68 may have a specific thickness, such as in the range of 0.3-30 μm, which may be controlled even more precisely in the range of 2-5 μm, and be composed from a material having a ceramic base. Accordingly, the coating 68 may have a substantially homogenous crystalline structure, i.e., other than having a small portion of common impurities, and be primarily composed of a base ceramic material. Alternatively, the coating 68 may have a matrix composite structure purposefully incorporating both ceramic-ceramic or ceramic and non-ceramic materials. Such a matrix structure of the coating 68 may, for example, be a silicon carbide, silicon nitride, chromium carbide, zirconia, carbon-carbon, or metal-ceramic composite.

The inner surface 66-1 of the bushing 66 may similarly include the ceramic-based coating 68 to further reduce abrasion between the shaft 64 and the bushing 66. Similar to that on the outer surface 64-1 of the shaft 64, the coating 68 on the inner surface 66-1 may have a thickness in the range of 0.3-30 μm and be controlled more precisely in the range of 2-5 μm. Additionally, the coating 68 may cover the inner surface 66-1 either entirely or partially according to the above discussion with respect to locations of highest specific loading. The coating 68 may be applied via a process of physical vapor deposition (PVD) or chemical vapor deposition (CVD). PVD is a type of coating method used to deposit thin films by the condensation of a vaporized form of the desired film material onto the surface of a workpiece, in the present case the coating 68 on the outer surface 64-1 and/or the inner surface 66-1. PVD involves purely physical processes such as high-temperature vacuum evaporation with subsequent condensation, or plasma sputter bombardment rather than involving a chemical reaction at the surface to be coated as in chemical vapor deposition. CVD is a type of coating method used to deposit thin films by condensation of a vaporized form of the desired film material onto the surface of a workpiece, such as the coating 68 on the outer surface 64-1 and/or the inner surface 66-1.

The coating 68 may also be applied via a process of thermal spray. Thermal spraying techniques are coating processes in which heated or melted material is sprayed onto a surface of a workpiece. During the process, the feedstock, i.e., coating precursor, is heated by electrical means, such as plasma or arc, or chemical means, such as a combustion flame. The material for thermal spraying of the coating 68 is fed in powder form, heated to a molten or semi-molten state and accelerated toward the outer surface 64-1 or the inner surface 66-1 in the form of micrometer-size particles. Combustion or electrical arc discharge is usually used as the source of energy for thermal spraying. Resulting coatings are made by the accumulation of numerous sprayed particles. The thermally spray coated surfaces may need to be ground and polished to maintain a smooth surface finish with surface rougness (Ra) of less than 1 micron. By contrast, the PVD or CVD coated surfaces may not need to be polished to maintain the required Ra of less than 1 micron, at least in part due to appreciably smaller coating thickness as compared to thermally sprayed on coatings.

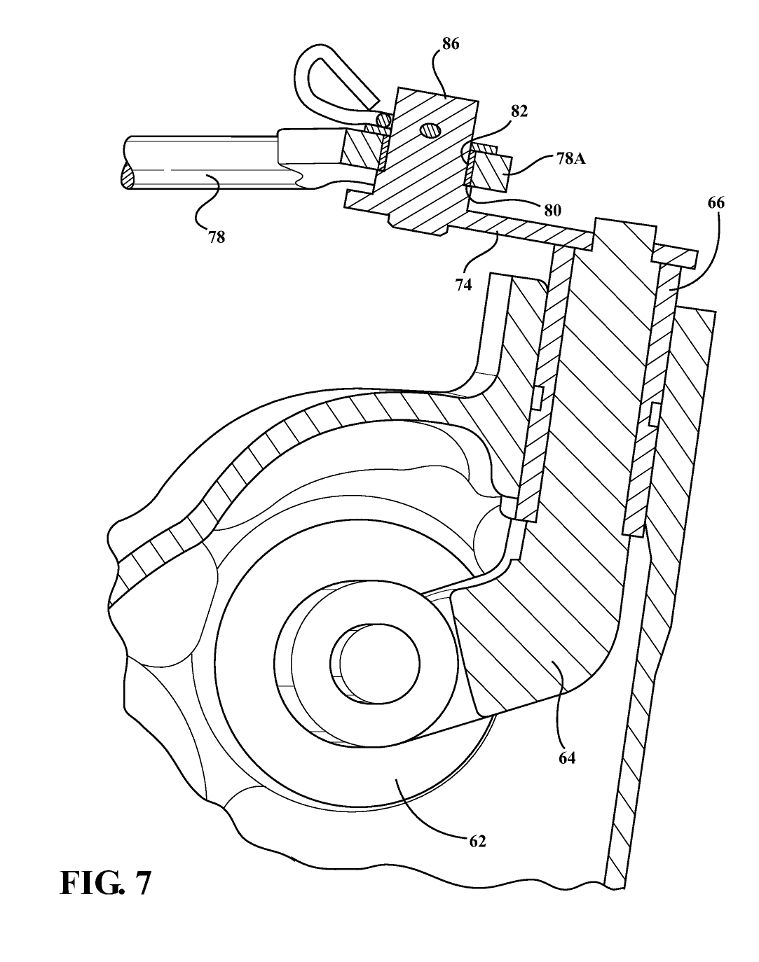

As shown in FIGS. 5-6, in place of the coating 68 on the inner surface 66-1 of the bushing 66, the inner surface may include one or more inserts configured, i.e., designed and formed, at least partially from the ceramic-based material. Accordingly, each insert may be configured as discrete sections 72A (shown in FIG. 5) or as a continuous sleeve 72B (shown in FIG. 6) specifically arranged at the predetermined locations 70 of highest specific loading discussed above. Accordingly, the discrete sections 72A may be spaced apart or positioned adjacent to one another, as required by the actual locations 70 of highest specific loading. An edge radius of approximately 0.3 mm or greater may be maintained on surfaces of discrete sections 72A and continuous sleeve 72B that could come in contact with the shaft 64 to avoid sharp edge cutting effect and damage to the shaft. A single continuous sleeve 72B that extends to cover all locations 70 between the bushing 66 and the shaft 64 may also be provided. Accordingly, and similar to the coating 68, the inserts in the form of sections 72A or sleeve 72B can be provided to reduce abrasion between the shaft 64 and the bushing 66. The inserts 72A, 72B do not necessarily need to be constructed of monolithic material, for example, the inserts could be shaped from a metallic alloy and then have their outer surface coated with a ceramic-based material.

As shown in FIGS. 2-3, the turbocharger 36 additionally includes an arm 74 fixed to the shaft 64. Furthermore, the turbocharger 36 includes an actuator 76 having a rod 78 that is operatively connected to the arm 74 via a rod end 78A. The actuator 76 is configured to displace or rotate the arm 74 to thereby selectively open and close the valve 62. As shown in FIG. 7, the rod end 78A includes an insert or multiple inserts 80 configured, i.e., designed and formed, from the ceramic-based material. In the case of multiple inserts 80, such inserts may be spaced apart or positioned adjacent to one another. The rod end 78A defines an aperture 82. The arm 74 includes a pin 86 that is engaged with the aperture 82, thus providing and securing an interface 84 between the rod end 78A and the pin. Additionally, the insert 80 is disposed at the interface 84. An edge radius of approximately 0.3 mm or greater may be maintained on surfaces of insert(s) 80 that could come in contact with the pin 86 to avoid sharp edge cutting effect and damage to the pin.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. An internal combustion engine comprising:
a cylinder configured to receive an air-fuel mixture for combustion therein;
a reciprocating piston disposed inside the cylinder and configured to exhaust post-combustion gases therefrom; and
a turbocharger in fluid communication with the piston and configured to pressurize an airflow being received from the ambient and deliver the pressurized airflow to the cylinder, the turbocharger including:
a turbine housing and a compressor cover;
a rotating assembly having a turbine wheel disposed inside the turbine housing and a compressor wheel disposed inside the compressor cover, wherein the rotating assembly is rotated about an axis by the post-combustion gases; and
a waste-gate assembly configured to selectively redirect at least a portion of the post-combustion gases away from the turbine wheel and thereby limit rotational speed of the rotating assembly and a pressure of the airflow received from the ambient, the waste-gate assembly having:
a valve, a rotatable shaft connected to the valve, and a bushing fixed relative to the turbine housing and disposed concentrically around the shaft such that the shaft rotates inside the bushing to thereby selectively open and close the valve, wherein the shaft is defined by an outer surface in contact with the bushing, and wherein the outer surface includes a coating composed of a ceramic-based material.

2. The engine of claim 1, wherein the bushing is defined by an inner surface in contact with the shaft, and wherein the inner surface is at least partially coated with the ceramic-based material.

3. The engine of claim 1, wherein the coating is applied via one of a process of physical deposition and thermal spray.

4. The engine of claim 1, wherein the bushing is defined by an inner surface in contact with the shaft, and wherein the inner surface includes an insert configured at least partially from the ceramic-based material.

5. The engine of claim 4, wherein the insert is configured as a continuous sleeve.

6. The engine of claim 1, wherein the turbocharger further includes an arm fixed to the shaft, and an actuator having a rod operatively connected to the arm via a rod end and configured to displace the arm to thereby selectively open and close the valve, wherein the rod end includes an insert configured from the ceramic-based material.

7. The engine of claim 6, wherein the rod end defines an aperture and the arm includes a pin that is engaged with the aperture thereby providing an interface between the rod end and the pin, and wherein the insert is disposed at the interface.

8. The engine of claim 1, wherein the ceramic-based material is a matrix composite of ceramic and non-ceramic materials.

9. The engine of claim 8, wherein the ceramic-based material is one of a silicon carbide, silicon nitride, chromium carbide, zirconia, carbon-carbon composite, and metal-ceramic composite.

10. The engine of claim 1, wherein the ceramic-based material has a homogenous crystalline structure.

11. A turbocharger for pressurizing an airflow for delivery to an internal combustion engine that generates post-combustion gases, the turbocharger assembly comprising:
a turbine housing and a compressor cover;
a rotating assembly having a turbine wheel disposed inside the turbine housing and a compressor wheel disposed inside the compressor cover, wherein the rotating assembly is rotated about an axis by the post-combustion gases; and
a waste-gate assembly configured to selectively redirect at least a portion of the post-combustion gases away from the turbine wheel and thereby limit rotational speed of the rotating assembly and a pressure of the airflow, the waste-gate assembly having:
a valve, a rotatable shaft connected to the valve, and a bushing fixed relative to the turbine housing and disposed concentrically around the shaft such that the shaft rotates inside the bushing to thereby selectively open and close the valve, wherein the shaft is defined by an outer surface in contact with the bushing, and wherein the outer surface includes a coating composed of a ceramic-based material.

12. The turbocharger of claim 11, wherein the bushing is defined by an inner surface in contact with the shaft, and wherein the inner surface is at least partially coated with the ceramic-based material.

13. The turbocharger of claim 11, wherein the coating is applied via one of a process of physical deposition and thermal spray.

14. The turbocharger of claim 11, wherein the bushing is defined by an inner surface in contact with the shaft, and wherein the inner surface includes an insert configured at least partially from the ceramic-based material.

15. The turbocharger of claim 14, wherein the insert is a continuous sleeve.

16. The turbocharger of claim 11, further comprising an arm fixed to the shaft, and an actuator having a rod operatively connected to the arm via a rod end and configured to displace the arm to thereby selectively open and close the valve, wherein the rod end includes an insert configured from the ceramic-based material.

17. The turbocharger of claim 16, wherein the rod end defines an aperture and the arm includes a pin that is engaged with the aperture thereby providing an interface between the rod end and the pin, and wherein the insert is disposed at the interface.

18. The turbocharger of claim 11, wherein the ceramic-based material is a matrix composite of ceramic and non-ceramic materials.

19. The turbocharger of claim 18, wherein the ceramic-based material is one of a silicon carbide, silicon nitride, chromium carbide, zirconia, carbon-carbon composite, and metal-ceramic composite.

20. The turbocharger of claim 11, wherein the ceramic-based material has a homogenous crystalline structure.
